(19) United States
(12) Patent Application Publication
(10) Pub. No.: US 2026/0257529 A1
(43) Pub. Date: Sep. 3, 2026

(54) AIR CONDITIONER

(71) Applicants: DENSO AIRCOOL CORPORATION, Azumino-shi (JP); KOMATSU LTD., Tokyo (JP)

(72) Inventors: Naoto MOMOSE, Azumino-shi (JP); Naoki HAGIWARA, Azumino-shi (JP); Naoya NOGUCHI, Tokyo (JP); Hirofumi KOTAKI, Tokyo (JP); Koji NAGAMI, Tokyo (JP)

(21) Appl. No.: 19/655,485

(22) Filed: Apr. 22, 2026

Related U.S. Application Data
(63) Continuation of application No. PCT/JP2024/036122, filed on Oct. 9, 2024.

(30) Foreign Application Priority Data
Oct. 31, 2023 (JP) 2023-186947

(51) Int. Cl. B60H 1/00; B60H 1/24

(52) U.S. Cl. CPC B60H 1/00564; B60H 1/242; B60H 1/244

(57) ABSTRACT

An air mix duct forms an air passage. A passage forming member is provided inside the air mix duct and forms a partitioned passage that partitions a part of the air passage to guide cold air and warm air blown from an air conditioning case to a middle of the air passage. An outer passage is formed in the air passage of the air mix duct on an area opposite the partitioned passage with respect to the passage forming member. A side plate is a wall of the air mix duct that forms the outer passage. A guide wall is provided on a downstream side from the passage forming member in the air mix duct. The guide wall is configured to extend in a direction toward an imaginary line that extends a passage center line of the partitioned passage in a downstream side from the side plate.

### CROSS REFERENCE TO RELATED APPLICATION

The present application is a continuation application of International Patent Application No. PCT/JP2024/036122 filed on Oct. 9, 2024, which designated the U.S. and is based on and claims the benefit of priority from Japanese Patent Application No. 2023-186947 filed on Oct. 31, 2023, the contents of which are incorporated herein by reference.

### TECHNICAL FIELD

The present disclosure relates to an air conditioner for air conditioning a cabin of vehicle such as construction machinery and the like.

### BACKGROUND

Air conditioners for vehicles need to be compact to be disposed on the vehicles. In the above aspects, or in other aspects not mentioned, there is a need for further improvements in an air conditioner.

### SUMMARY

According to one aspect of the present disclosure, an air conditioner for an inner space of a cabin, the air conditioner comprising: a cooling device that cools air; a heating device that is located downstream of the cooling device and heats the air; an air conditioning case that accommodates the cooling device and the heating device and blows out cold air that passes through the cooling device and bypasses the heating device, and warm air that passes through the heating device; an air mix duct that forms an air passage through which cold air and warm air flows from the air conditioning case; a passage forming member that is provided inside the air mix duct and forms a partitioned passage which partitions a part of the air passage so that cold air and warm air blown from the air conditioning case are guided to a middle of the air passage; an outer passage that is formed in the air passage of the air mix duct in an area opposite to the partitioned passage with respect to the passage forming member; a side plate that forms an outer passage of the air mix duct; a guide wall that is provided downstream from the passage forming member in the air mix duct and is configured to extend in a direction toward an imaginary line that extends a passage center line of the partitioned passage in a downstream side from the side plate forming the outer passage; and a blowout opening that is provided in the air mix duct and blows out air flowing in the outer passage.

According to this, cold air and warm air blown from the air conditioning case flows through the partitioned passage formed by the passage forming member, then flows through the outer passage so that at least some of air is guided by the guide wall to make a U-turn flow and is blown out from the blowout opening. Therefore, the air conditioner is possible to mix cold air and warm air in a short length of a passage by flowing cold air and warm air to form a U-turn flow. Therefore, the air conditioner does not require long ducts, which conventional air-mix type air conditioners require, and may be mounted in various locations, such as cabin ceilings, to secure a larger living space in the cabin. In addition, the air conditioner uses an air-mix system, which allows a blowout temperature to be adjusted linearly with respect to changes of a temperature setting value. Furthermore, the air conditioner does not require a flow control valve, which conventional reheat-type air conditioners require, thus reducing a size and manufacturing cost of the air conditioner.

The reference numerals in parentheses attached to the components and the like indicate an example of correspondence between the components and the like and specific components and the like described in an embodiment to be described below.

### BRIEF DESCRIPTION OF DRAWINGS

FIG. 1 is a diagram schematically showing a construction machinery mounted with an air conditioner according to a first embodiment.

FIG. 2 is a diagram showing a cross-section of the air conditioner in a part II of FIG. 1.

FIG. 3 is a cross-sectional view of an inside of an air mix duct at a line III-III FIG. 2.

FIG. 4 is a diagram of the inside of the air mix duct of a view excluding a top plate of the air mix duct.

FIG. 5 is an explanatory view of a first partitioned passage and a second partitioned passage.

FIG. 6 is a cross-sectional view of an inside of an air mix duct in an air conditioner according to a second embodiment, and is a diagram of a part corresponding to FIG. 3.

FIG. 7 is a cross-sectional view of an inside of an air mix duct in an air conditioner according to a third embodiment, and is a diagram of a part corresponding to FIG. 3.

FIG. 8 is a diagram schematically showing a construction machinery mounted with an air conditioner according to a fourth embodiment.

FIG. 9 is a cross-sectional view at a line IX-IX in FIG. 8.

FIG. 10 is a diagram schematically showing a cabin of a construction machine mounted with an air conditioner of a first comparative example.

FIG. 11 is a diagram schematically showing a cabin of a construction machinery mounted with an air conditioner of a second comparative example.

FIG. 12 is a cross-sectional view of an inside of an air mix duct in an air conditioner of a third comparative example, and is a diagram of a part corresponding to FIG. 3.

### DETAILED DESCRIPTION

JP2022-44924A discloses a reheat type air conditioner installed in a cabin ceiling of construction machinery and the like. The reheat type air conditioner is one that is configured so that all air that has passed through a cooling equipment in an air conditioning case passes through a heating equipment. According to this, it is possible to blow out temperature-controlled air from a blowout outlet even if a length between the blowout outlet and the air conditioning case in the cabin is short.

However, the reheat type air conditioner adjusts a blowout temperature by adjusting a flow rate of hot water flowing through the heating equipment, which requires a flow control valve to adjust the flow rate of the hot water, resulting in a larger air conditioner and higher manufacturing costs. The reheat type air conditioners also have the problem that it is difficult to adjust the blowout temperature linearly to changes of a temperature setting value. To solve those problems, an air mix type air conditioner may be adopted. An air conditioner of the air mix type is configured to be able to mix cold air that has passed through a cooling device and bypassed a heating device and warm air that has passed through the heating device in the air conditioning case and blow out the mixed air. However, if an air-mix type air conditioner is mounted in a ceiling of a cabin of a construction machinery, etc., a length of a duct connecting a blowout outlet in the cabin to an air conditioning case is not able to make long enough. Therefore, there could be disadvantages that cold air and warm air not being sufficiently mixed in a short duct could be blown out from a blowout outlet.

It is an object to provide an air conditioner of the air mix type capable of blowing temperature-controlled air even when a length between a blowout outlet in the cabin and the air conditioning case is short.

Embodiments of the present disclosure are now described with reference to the drawings. In the following embodiments, the same or equivalent parts are denoted by the same reference numerals, and their descriptions will be omitted. First Embodiment

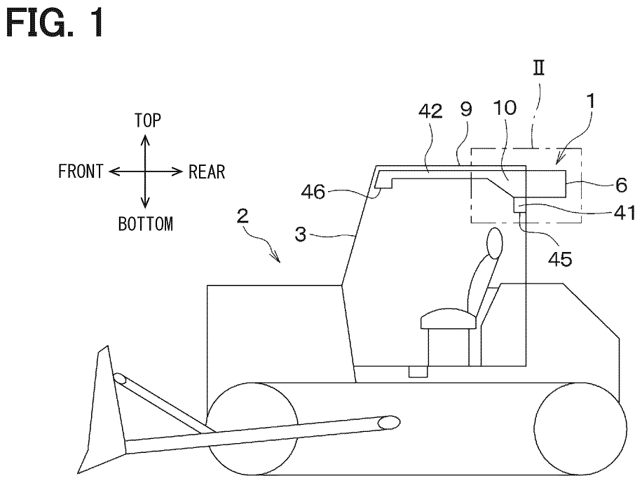

A first embodiment is described below. As shown in FIG. 1, an air conditioner 1 of a first embodiment air-conditions an interior space of a cabin 3 of a construction machine 2, such as a bulldozer, for example. Hereinafter the interior space of the cabin 3 may be referred to as an in-cabin-space. The air conditioner 1 may be disposed on a location above a center in the vertical direction of the cabin 3. Specifically, the air conditioner 1 is located at a rear portion of a ceiling 9 of the cabin 3. In each drawing, a vertical direction in the cabin 3 is indicated by both arrows with TOP and BOTTOM, a forward and backward direction in the cabin 3 is indicated by both arrows with FRONT and REAR, and a left and right direction in the cabin 3 is indicated by both arrows with LEFT and RIGHT.

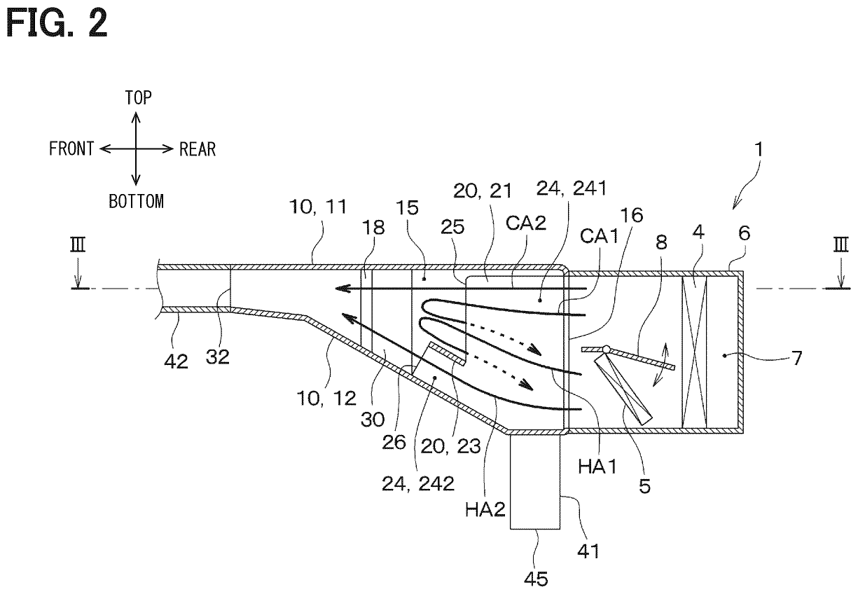

As shown in FIGS. 2 to 4, the air conditioner 1 has a cooling device 4, a heating device 5, an air conditioning case 6, an air mix duct 10, a passage forming member 20, guide walls 30, first blowout openings 31, a second blowout opening 32, etc.

The cooling device 4 is an evaporator that is a part of a refrigeration cycle system not shown. The cooling device 4 has tubes, not shown, through which a refrigerant circulating in the refrigeration cycle system flows and fins, not shown, which are connected to the tubes. The cooling device 4 cools air by evaporating the refrigerant by performing heat exchange between the refrigerant and air passing through passages between the tubes and between the fins.

The heating device 5 is located downstream of the cooling device 4 in the airflow direction. The heating device 5 is, e.g., a heater core through which a part of a cooling water of an engine of the construction machinery 2 flows. The heating device 5 has tubes, not shown, through which an engine cooling water flows and fins, not shown, which are connected to the tubes. The heating device 5 heats air by performing heat exchange between the engine cooling water, i.e., hot water, and air passing through between the tubes and between the fins.

The cooling device 4 and the heating device 5 are accommodated in the air conditioning case 6. Air outside the cabin (i.e., an outside air) and air in the in-cabin-space (i.e., an inside air) are supplied from a blower unit not shown to a space 7 located on an upstream side rather than the cooling device 4 in the air conditioning case 6. The air conditioning case 6 blows out cold air that bypasses the heating device 5 after passing through the cooling device 4, and warm air that passes through the heating device 5 after passing through the cooling device 4. The air mix door 8 is provided between the cooling device 4 and the heating device 5. The air mix door 8 adjusts an air flow rate ratio between cold air and warm air. Cold air and warm air blown from the air conditioning case 6 is supplied to the air mix duct 10.

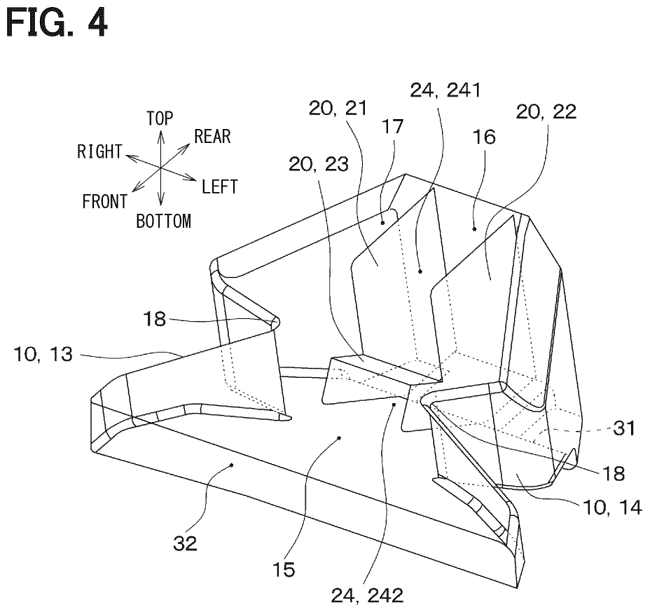

The air mix duct 10 is located downstream of the air conditioning case 6. The air mix duct 10 has a top plate 11, a bottom plate 12, a right side plate 13, and a left side plate 14. The right side plate 13 and the left side plate 14 may be collectively referred to as the side plates 13 and 14. FIG. 4 illustrates the air mix duct 10 without the top panel 11. The air mix duct 10 forms, in an inner side of the top plate 11, the bottom plate 12, the right side plate 13, and the left side plate 14, an air passage 15 through which cold air and warm air blown from the air conditioning case 6 flows. That is, the entire area inside the air mix duct 10 is called the air passage 15.

The air mix duct 10 is provided with an air inlet 16 and a plurality of blowout openings 31 and 32. The air inlet 16 is an opening surrounded by the top plate 11, the bottom plate 12, the right side plate 13, and the left side plate 14 at a side of the air mix duct 10 to the air conditioning case 6, and is fluidly connected to the air conditioning case 6. Therefore, the air mix duct 10 is supplied with cold air and warm air from the air conditioning case 6.

Among the plurality of blowout openings, the opening on the bottom plate 12 at a part on a side to the air conditioning case 6 of the air mix duct 10 is called a first blowout opening 31. The first blowout openings 31 are openings for blowing out air flowing through the outer passages 17, which is formed in a left and right outer regions of the passage forming member 20, as described below. As shown in FIGS. 1 and 2, rear defroster ducts 41 as examples of rear ducts that blow air from a rear side of the cabin 3 are connected to the first blowout openings 31. Specifically, the rear defroster ducts 41 are ducts that blow air toward a rear window of the cabin 3. Relatively short length ducts are employed as the rear defroster ducts 41.

Among the plurality of blowout openings, an opening enclosed by the top plate 11, the bottom plate 12, the right side plate 13, and the left side plate 14 at a side opposite to the air conditioning case 6 is referred to as a second blowout opening 32. A front defroster duct 42 as an example of a front duct that blows air from a front side of the cabin 3 is connected to the second blowout opening 32. The front defroster duct 42 is a duct that blows air toward the front window of the cabin 3.

As shown in FIGS. 2 through 5, a passage forming member 20 is disposed inside the air mix duct 10. The passage forming member 20 has a first plate 21 and a second plate 22 provided to oppose each other, and a third plate 23 connecting a portion of the first plate 21 and a portion of the second plate 22. The passage forming member 20 forms a partitioned passage 24 that defines a part of the air passage 15 in a region between the first plate 21 and the second plate 22. The air passage 15 defined by the passage forming member 20 is fluidly connected to the air inlet 16 of the air mix duct 10. Therefore, air blown from the air conditioning case 6 flows into the partitioned passage 24 from the air inlet 16. The partitioned passage 24 is a passage that guides cold air and warm air blown from the air conditioning case 6 to a middle of the air passage 15.

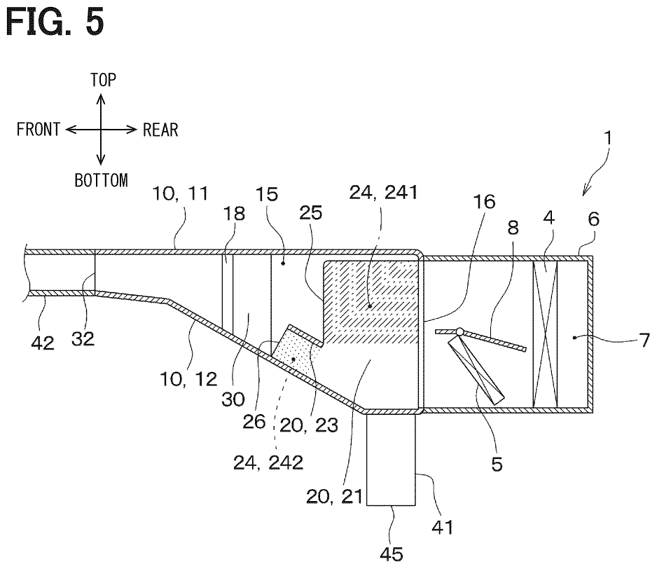

In detail, as shown in FIG. 5, the partitioned passage 24 has a first partitioned passage 241 and a second partitioned passage 242. In FIG. 5, the first partitioned passage 241 is shown with single-dotted hatching and the second partitioned passage 242 is shown with dashed hatching for illustrative purposes. The first partitioned passage 241 and the second partitioned passage 242 are continuous spaces, but are separated by the third plate 23.

The first partitioned passage 241 is a passage provided at a location corresponding to both the cooling device 4 and the heating device 5. The location corresponding to both the cooling device 4 and the heating device 5 means a location where both cold air that passes through the cooling device 4 and bypasses the heating device 5 and warm air that passes through the heating device 5 flow. An outlet of the first partitioned passage 241 is referred to as a first outlet 25. The first outlet 25 is located in the middle of the air passage 15 in a longitudinal direction from the air inlet 16 to the second blowout opening 32. Therefore, the first partitioned passage 241 may guide both cold air and warm air blown from the air conditioning case 6 to the middle of the air passage 15 in the air mix duct 10.

On the other hand, the second partitioned passage 242 is a passage provided at a location corresponding to the heating device 5. The location corresponding to the heating device 5 means a location where warm air passed through the heating device 5 mainly flows. An outlet of the second partitioned passage 242 is referred to as a second outlet 26. The second outlet 26 is located on a side closer to the second blowout opening 32 than the first outlet 25. The third plate 23 is located on a side opposite to the bottom plate 12 of the air mix duct 10 of the second partitioned passage 242. Therefore, the second partitioned passage 242 is in a shape of a tunnel partitioned by the first plate 21, the second plate 22, the third plate 23 and the bottom plate 12. The second partitioned passage 242 is capable of mainly guiding warm air from air blown through mainly the heating device 5 in the air conditioning case 6, to a side of the second blowout opening 32 rather than the first outlet 25.

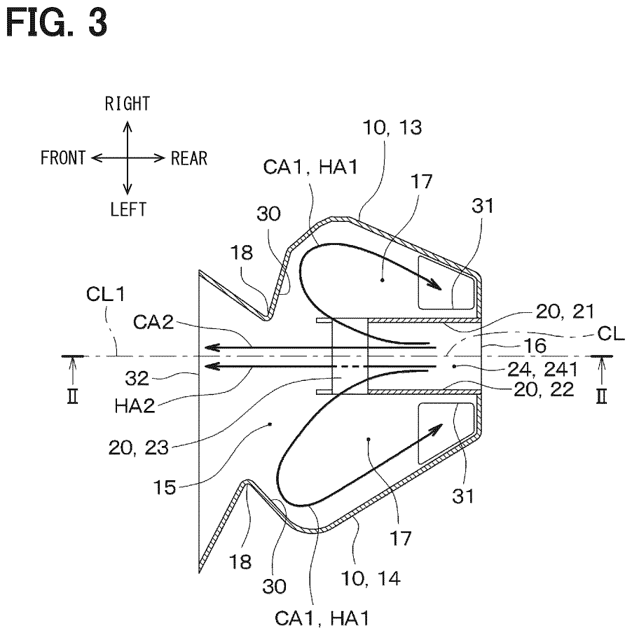

As shown in FIGS. 3 and 4, the outer passages 17 are formed in the air passage 15 in the air mix duct 10 in an area opposite to the partitioned passage 24 with respect to both the first plate 21 and the second plate 22 that constitute the passage forming member 20, that is, in the areas outside of both a left side and a right side of the passage forming member 20. The outer passages 17 are passages formed in the air passage 15 in an area between the right side plate 13 of the air mix duct 10 and the first plate 21 of the passage forming member 20, and in an area between the left side plate 14 of the air mix duct 10 and the second plate 22 of the passage forming member 20, respectively.

Each of the right side plate 13 and the left side plate 14 of the air mix duct 1 is provided with a concave portion 18, i.e., a neck portion, that is concaved toward an imaginary line CL1, which is obtained by extending the flow center line CL of the partitioned passage 24 in a downstream side, at a location on a downstream side from the passage forming member 20. The concave portions 18 narrows the air passage 15. Wall portions, which are parts of the concave portions 18, facing a side of the passage forming member 20 and a side of the outer passages 17 provide the guide walls 30. That is, the guide walls 30 are provided on a downstream side of the passage forming member 20 in the air mix duct 10, and are configured to extend from the side plates 13 and 14 forming the outer passages 17 toward the imaginary line CL1 that extends the flow center line CL of the partitioned passage 24 in a downstream side. Each one of the guide walls 30 is capable of guiding at least a part of air that has passed through the partitioned passage 24 to make a U-turn flow in the outer passage 17. In the first embodiment, the side plates 13 and 14 and the guide wall 30 are formed as one continuous member. However, this configuration does not limit this disclosure. For example, the guide walls 30 and the side plates 13 and 14 do not have to be integral parts, and moreover, the guide walls 30 does not have to be connected to the side plates 13 and 14.

The guide wall 30 on a right side is separated from the guide wall 30 on a left side. Therefore, air that has passed through the partitioned passage 24 and is not guided by the guide walls 30 passes through a gap space formed between the guide walls 30 on the left side and the right side and is blown out from the second blowout opening 32. The first outlet 25 of the first partitioned passage 241 and the second outlet 26 of the second partitioned passage 242 both face the gap space formed between the guide walls 30 on the left side and the right side. The second outlet 26 is located closer to the gap space formed between the guide walls 30 on the left side and the right side, i.e., closer to the second blowing opening 32 than the first outlet 25.

As shown by arrow symbols CA1 and HA1 in FIGS. 2 and 3, cold air and warm air blown from the first outlet 25 of the first partitioned passage 241 spread radially in the air passage 15 at a downstream side of the first outlet 25. A part of cold air and warm air is then guided by each one of the guide walls 30 to flow in a U-turn flow in the outer passage 17, and is blown out through the first blowout opening 31. In this case, cold air and warm air are sufficiently mixed even in a short length by flowing in a U-turn manner, and are blown from the first blowout opening 31 through the rear defroster duct 41 into the in-cabin-space.

As shown by an arrow symbol CA2, the remaining other part of cold air and warm air blown out of the first outlet 25 of the first partitioned passage 241 flows unobstructed in a path by the guide walls 30, specifically, passing the gap space between the guide walls 30 on the left and the right, and is blown out of the second blowout opening 32. Furthermore, as shown by an arrow symbol HA2, most of warm air blown from the second outlet 26 of the second partitioned passage 242 flows unobstructed in a path by the guide walls 30, specifically, passing the gap space between the guide walls 30 on the left and the right, and is blown from the second blowout opening 32. Therefore, by guiding warm air to the second blowout opening 32 by the second partitioned passage 242, it is possible to reduce variation of a temperature of air blown from the first blowout opening 31 and a temperature of air blown from the second blowout opening 32. As a result, it is possible to reduce variation in a temperature of air blown from the first blowout opening 31 through the rear defroster duct 41 into the in-cabin-space and a temperature of air blown from the second blowout opening 32 through the front defroster duct 42 into the in-cabin-space.

As shown in FIG. 3, in a lateral cross-sectional view perpendicular to the vertical direction of the cabin 3, hereinafter simply referred to as a lateral cross-sectional view, each one of the outer passages 17 has a shape which gradually becomes smaller from a side of the guide wall 30 toward a side of the first blowout opening 31. As shown in FIG. 2, in a vertical cross-sectional view parallel to the vertical direction of the cabin 3, hereinafter simply referred to as a vertical cross-sectional view, each one of the outer passages 17 has a shape which gradually becomes larger from a side of the guide wall 30 toward a side of the first blowout opening 31. This shape also contributes to mix warm air and cold air flowing in the outer passages 17 more efficiently in a short length and it is possible to blow out mixed air from the first blowout opening 31.

Furthermore, as shown in FIG. 2, in the vertical cross-sectional view, the air passage 15 formed in the air mix duct 10 has a shape which gradually becomes smaller from a side of the air conditioning case 6 toward a side of the second blowout opening 32. This shape also contributes to mix warm air and cold air flowing in the air passage 15 more efficiently in a short length and it is possible to blow out mixed air from the second blowout opening 32. In addition, it is possible to provide a large living space in the in-cabin-space by reducing a body size of the air mix duct 10 in the vertical direction.

Hereinafter, in order to be compared with the air conditioner 1 according to the first embodiment described above, air conditioners 1 according to a first through a third comparative example are described.

### First Comparative Example

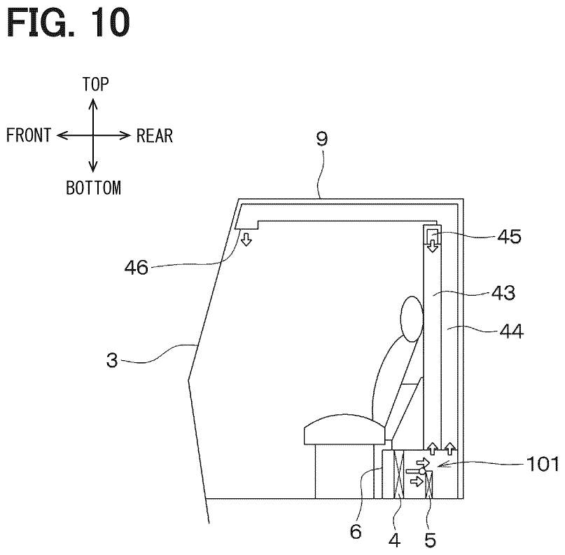

As shown in FIG. 10, an air conditioner 101 of the first comparative example is also an air mix type air conditioner. However, the air conditioner 101 in the first comparative example does not have the air mix duct 10 described in the first embodiment above, so it requires long length ducts 43 and 44 to mix cold air and warm air blown out of the air conditioning case 6. Therefore, the air conditioner 101 in the first comparative example has the air conditioning case 6 located at a lower rear side of the cabin 3 and long length ducts 43 and 44 extending in the vertical direction of the cabin 3. Cold air and warm air blown from the air conditioning case 6 are mixed by passing through the long length ducts 43 and 44, and then blown into the in-cabin-space from a rear blowout outlet 45 and a front blowout outlet 46, respectively.

The air conditioner 101 in the first comparative example requires the long length ducts 43 and 44 that extend in the vertical direction of the cabin 3, which reduces a living space on a rear region of the cabin 3. In addition, the air conditioner 101 in the first comparative example requires the long length ducts 43 and 44, which increases manufacturing costs.

### Second Comparative Example

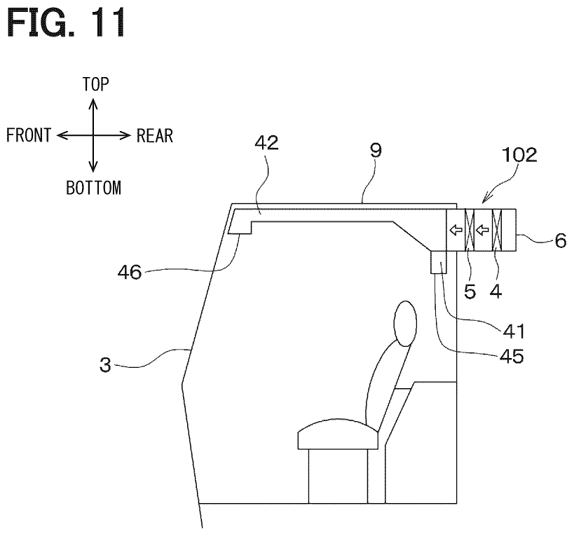

As shown in FIG. 11, the air conditioner 102 of the second comparative example is a reheat type air conditioner. The reheat type air conditioner is one that is configured so that all air that has passed through the cooling device 4 in the air conditioning case 6 passes through the heating device 5. Therefore, the air conditioner 102 in the second comparative example does not require a long length ducts 43 and 44 and can be disposed on the ceiling 9 of the cabin 3.

However, since the reheat type air conditioner adjusts a blowout air temperature by adjusting a flow rate of hot water (specifically, engine cooling water) flowing through the heating device 5, a flow control valve is required to adjust the flow rate of hot water. As a result, the reheat type air conditioners have disadvantages such as a larger body size of the air conditioner and higher manufacturing costs. The reheat type air conditioners also have disadvantages that it is difficult to adjust a blowout temperature linearly with respect to changes of a temperature setting value.

### Third Comparative Example

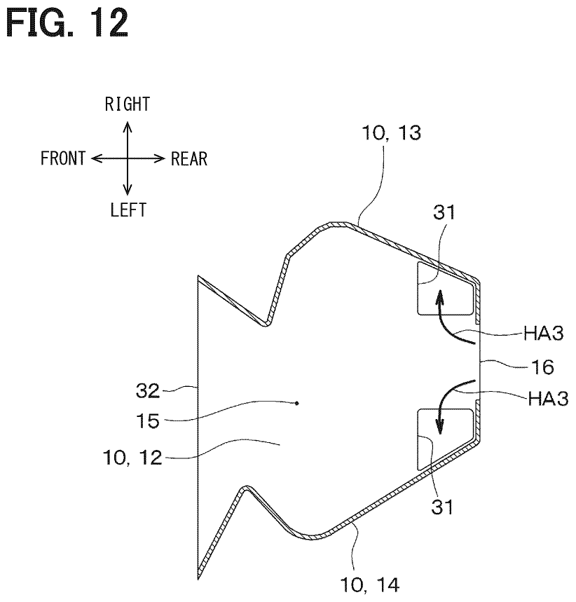

As shown in FIG. 12, an air conditioner of the third comparative example is an air mix type and is configured without a passage forming member 20 inside the air mix duct 10, compared to the first embodiment. In this case, warm air that has passed through the heating device 5 is blown out of the lower area of the air inlet 16 of the air mix duct 10 (i.e., the area of the air inlet 16 closest to the bottom plate 12) into the air passage 15. Therefore, as shown by arrow symbol HA3, warm air adversely flows mainly to the first blowout opening 31, which is open at the bottom plate 12 near the air inlet 16. Thus, enough amount of warm air is not blown out from the second blowout opening 32. Therefore, the air conditioner in the third comparative example has a disadvantage that there is a large variation in airflow and temperature in air blown from the first blowout opening 31 and air blown from the second blowout opening 32.

### Function and Advantage of First Embodiment

Compared with the first to third comparative examples above, the air conditioner 1 of the first embodiment achieve the following advantages.
(1) The air conditioner 1 of the first embodiment has the air mix duct 10, the passage forming member 20, and the guide wall 30. The passage forming member 20 forms the partitioned passage 24 that guides air blown from the air conditioning case 6 to a middle of the air passage 15. That is, the guide walls 30 are provided on a downstream side of the passage forming member 20 in the air mix duct 10, and are configured to extend from the side plates 13 and 14 forming the outer passages 17 in a direction toward the imaginary line CL1 that is obtained by extending the flow center line CL of the partitioned passage 24 in a downstream side. According to this, cold air and warm air blown from the air conditioning case 6 flows through the partitioned passage 24 formed by the passage forming member 20, then flows through the outer passage 17 so that at least some of air is guided by the guide wall 30 to make a U-turn flow and is blown out from the first blowout opening 31. Therefore, the air conditioner 1 of the first embodiment is possible to mix cold air and warm air in a short length of a passage by flowing cold air and warm air in a U-turn flow. Therefore, since the air conditioner 1 of the first embodiment does not require long-distance ducts 43 and 44, which the air conditioner 101 of the first comparative example required, and can be mounted in various locations such as the ceiling 9 of the cabin 3, it is to provide a wide living space on a rear region of the cabin 3. In addition, the air conditioner 1 of the first embodiment does not require a flow adjustment valve, which the air conditioner 102 of the reheat type of the second comparative example required, by employing the air mix type. Therefore, the air conditioner 1 of the first embodiment can reduce a size and manufacturing cost of the air conditioner, and furthermore, can adjust a blowout temperature linearly with respect to changes in a temperature setting value.
(2) The air conditioner 1 of the first embodiment has the first blowout opening 31 provided on the air mix duct 10 that blows out air flowing in the outer passage 17 and the second blowout opening 32 provided on the air mix duct 10 at an opposite side of the first blowout opening 31 with respect to the guide wall 30. According to this, some of air that passes through the partitioned passage 24 is guided by the guide wall 30 and flows through the outer passage 17 and then blown out from the first blowout opening 31. On the other hand, some of the other air that passes through the partitioned passage 24 flows unobstructed in its path by the guide wall 30 and is blown out from the second blowout opening 32. Therefore, the air conditioner 1 can reduce variation in a blowout temperatures blown out from the first blowout opening 31 and the second blowout opening 32, respectively, by adjusting the shape and size of the guide wall 30. It is possible to reduce variation in amount of airflow blown out from the first blowout opening 31 and the second blowout opening 32, respectively.
(3) In the first embodiment, the partitioned passage 24 has the first partitioned passage 241 and the second partitioned passage 242. The first partitioned passage 241 guides cold air and warm air blown from the air conditioning case 6 to the first outlet 25 disposed at a middle of the air passage 15. The second partitioned passage 242 guides warm air blown from the air conditioning case 6 to the second outlet 26, which is located on a side to the second blowout opening 32 rather than the first outlet 25. According to this, if there is no passage forming member 20 in the air mix duct 10 shown in the third comparative example, warm air flowing through the air passage 15 in the air mix duct 10 is mainly blown out from the first blowout opening 31 and not so much from the second blowout opening 32. In contrast, the air conditioner 1 of the first embodiment can reduce variations in amount of airflow and temperature of air blown from the first blowout opening 31 and air blown from the second blowout opening 32 by guiding warm air to a side to the second blowout opening 32 by the second partitioned passage 242 of the passage forming member 20.
(4) In the first embodiment of the air conditioner 1, the rear defroster duct 41 is connected to the first blowout opening 31 and the front defroster duct 42 is connected to the second blowout opening 32. According to this, it is possible to reduce variations in amount of airflow and temperature of air blown from the blowout outlet 45 of the rear defroster duct 41 and air blown from the blowout outlet 46 of the front defroster duct 42.
(5) In the first embodiment, the air passage 15 formed in the air mix duct 10 has a shape which gradually becomes smaller from a side of the air conditioning case 6 to a side of the second blowout opening 32 in the vertical cross-sectional view. According to this, warm air and cold air flowing in the air passage 15 can be mixed more efficiently over a shorter length and blown from the second blowout opening 32. In addition, it is possible to provide a large living space in the in-cabin-space by reducing a body size of the air mix duct 10 in the vertical direction of the cabin 3.
(6) In the first embodiment, the outer passage 17 formed in the air mix duct 10 has a shape which gradually becomes smaller from a side of the guide wall 30 to a side of the first blowout opening 31 in a lateral cross-sectional view. The outer passage 17 has a shape that gradually increases in size from a side of the guide wall 30 to a side of the first blowout opening 31 in the vertical cross-sectional view. According to this, warm air and cold air flowing in the outer passage 17 can be mixed more efficiently over a shorter length and blown from the first blowout opening 31.
(7) The air conditioner 1 of the first embodiment is disposed on a location above a center in the vertical direction of the cabin 3. Specifically, the air conditioner 1 is disposed on the ceiling 9 of the cabin 3. According to this, the air conditioner 1 of the first embodiment can eliminate the long distance ducts 43 and 44 required by the air conditioner 101 of the first comparative example, thereby it is possible to provide a wider living space on a rear region of the cabin 3 and to reduce manufacturing costs.
(8) The air conditioner 1 of the first embodiment is mounted on the ceiling 9 of the cabin 3 of the construction machinery 2. According to this, it is possible to provide a wide living space within an in-cabin-space, and furthermore, to improve operator comfort by reducing a variation in amount of airflow and temperature of air blown from each one of the blowout outlets 45 and 46 by applying the air conditioner 1 for an air conditioning purpose for the cabin 3 of construction machinery 2.

### Second Embodiment

The second embodiment is described. The second embodiment is a modification of the configuration of the air mix duct 10, etc., with respect to the first embodiment, and is otherwise similar to the first embodiment, so only parts that differ from the first embodiment are described.

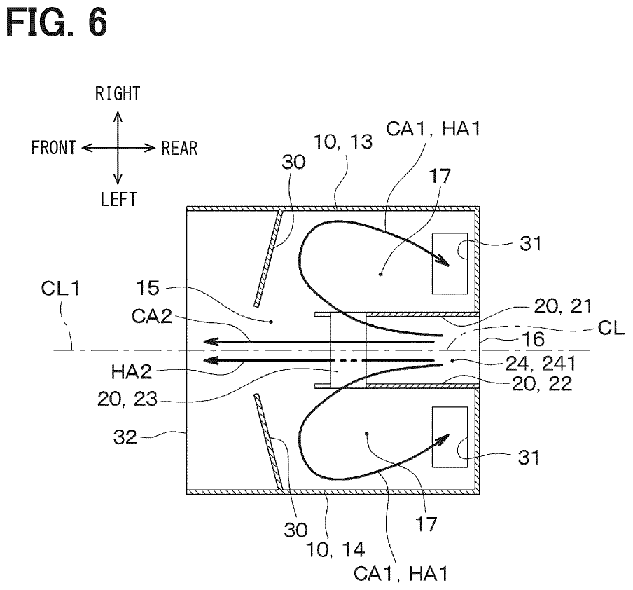

As shown in FIG. 6, the air mix duct 10 provided by the air conditioner 1 of the second embodiment is rectangular in outline in the lateral cross-sectional view. The inside of the air mix duct 10 is provided with the guide walls 30 configured to extend from the side plates 13 and 14 to the imaginary line CL1, which is obtained by extending the flow center line CL of the partitioned passage 24 in a downstream side, at a downstream side of the passage forming member 20.

The second embodiment described above can also achieve the same advantages as the first embodiment.

### Third Embodiment

The third embodiment is described below. The third embodiment is a modification of the configuration of the air mix duct 10, etc., with respect to the first embodiment, and is otherwise similar to the first embodiment, so only parts that differ from the first embodiment are described.

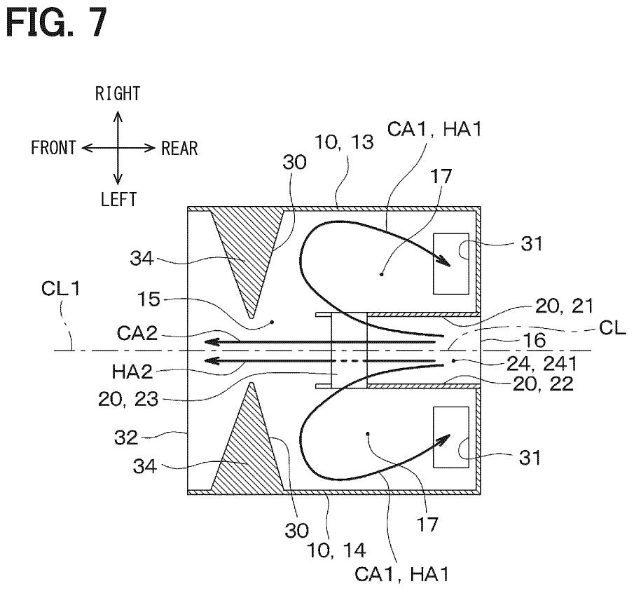

As shown in FIG. 7, the air mix duct 10 provided by the air conditioner 1 of the third embodiment is also rectangular in outline in the lateral cross-sectional view. Each one of the right side plate 13 and the left side plate 14 of the air mix duct 10 is provided with a triangular-shaped portion 34 protruding in a triangular shape toward the imaginary line CL1, which is obtained by extending the flow center line CL of the partitioned passage 24 in a downstream side, at a downstream side of the passage forming member 20. The triangular-shaped portions 34 provide inclined walls that face a side to the passage forming member 20 and a side to the outer passages 17 and are referred to as guide walls 30.

The third embodiment described above can also achieve the same advantages as the first embodiment.

### Fourth Embodiment

The fourth embodiment is described. The fourth embodiment is an embodiment which added a mode switching case and a face duct, etc. to the first embodiment, etc. The other parts are the same as the first embodiment, so only parts that differ from the first embodiment are described.

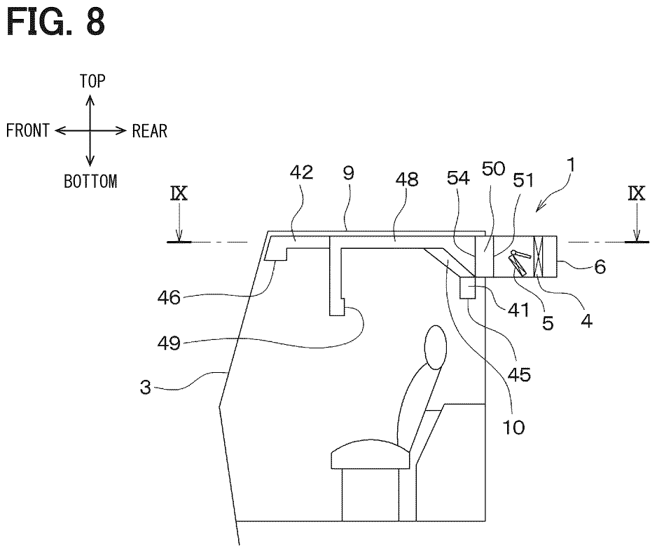

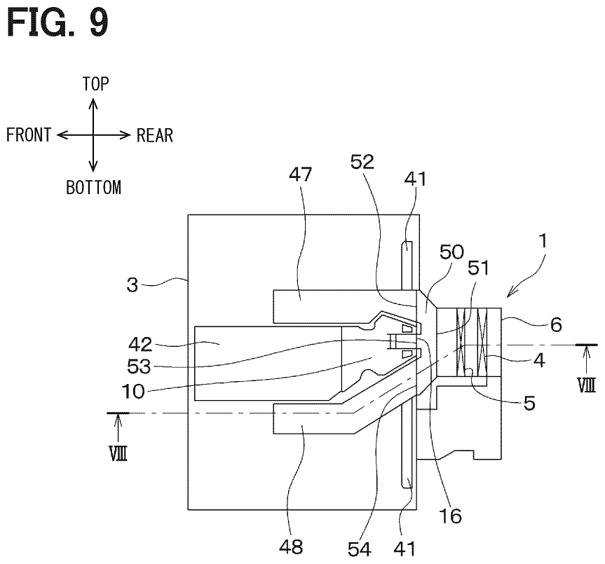

As shown in FIG. 8 and FIG. 9, the fourth embodiment of the air conditioner 1 has the mode switching case 50 between the air conditioning case 6, which houses the cooling device 4 and the heating device 5, and the air mix duct 10. An air inlet 51 of the mode switching case 50 is fluidly connected to the air conditioning case 6. Therefore, the mode switching case 50 is supplied with cold air and warm air from the air conditioning case 6.

The mode switching case 50 has a right side air outlet 52, a center air outlet 53, and a left side air outlet 54. The right side air outlet 52 is connected to a right side face duct 47, the center air outlet 53 is connected to the air mix duct 10, and the left side air outlet 54 is connected to a left side face duct 48. The right side face duct 47 and the left side face duct 48 are ducts that blow air-conditioned air from blowout outlets 49 toward an operator's upper body.

In the mode switching case 50, a mode switching door, not shown is provided. An airflow supplied from the air conditioning case 6 is oriented to and switched to the right side face duct 47 or the left side face duct 48 or the air mix duct 10 by the mode switching door. This allows the air conditioner 1 of the fourth embodiment to switch a blowout mode of the air-conditioning air to a face mode, a defroster mode, or a both mode.

The air conditioner 1 of the fourth embodiment described above can achieve the same advantages as the first embodiment, and in addition, it can execute the face mode.

### Other Embodiments

(1) In each of the above embodiments, the air conditioner 1 is described as devices mounted on a bulldozer as an example of the construction machinery 2. The air conditioner 1 may be mounted on various types of manned machinery such as construction machinery 2, e.g., hydraulic excavators, wheel loaders, dump trucks, and motor graders, and various types of agricultural machinery, e.g., tractors and combine harvesters.
(2) In each of the above embodiments, the air conditioner 1 is described as devices installed on the ceiling 9 of the cabin 3. However, it is not limited to them and may be installed anywhere, for example, at a bottom of the cabin 3.
(3) In each of the above embodiments, the air conditioner 1 is described as devices with the first blowout opening 31 and the second blowout opening 32 disposed on the air mix duct 10. However, the blowout opening may be only the first blowout opening 31.
(4) In the first and fourth embodiments above, the air mix duct 10 has an asymmetrical shape. However, the air mix duct 10 may has a symmetrical shape.

The present disclosure is not limited to the embodiments described above, and can be modified as appropriate. The above described embodiments and a part thereof are not irrelevant to each other, and can be appropriately combined with each other unless the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. Furthermore, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Furthermore, a shape, a positional relationship, or the like, if specified in each of the embodiments described above, is not necessarily limited to the specific shape, positional relationship, or the like unless it is specifically stated, or unless the shape, positional relationship, or the like is necessary to be the specific shape, positional relationship, or the like in principle.

(Various Aspects of Present Disclosure) The present disclosure described above can be understood from the following features, for example.

(Aspect 1) An air conditioner for an inner space of a cabin (3), the air conditioner comprising: a cooling device (4) that cools air; a heating device (5) that is located downstream of the cooling device and heats the air; an air conditioning case (6) that accommodates the cooling device and the heating device and blows out cold air that passes through the cooling device and bypasses the heating device, and warm air that passes through the heating device; an air mix duct (10) that forms an air passage (15) through which cold air and warm air flows from the air conditioning case; a passage forming member (20) that is provided inside the air mix duct and forms a partitioned passage (24) which partitions a part of the air passage so that cold air and warm air blown from the air conditioning case are guided to a middle of the air passage; an outer passage (17) that is formed in the air passage of the air mix duct in an area opposite to the partitioned passage with respect to the passage forming member; a side plate (13, 14) of the air mix duct that forms the outer passage; a guide wall (30) that is provided downstream from the passage forming member in the air mix duct and is configured to extend in a direction toward an imaginary line (CL1) that extends a passage center line (CL) of the partitioned passage in a downstream side from the side plate forming the outer passage; and a blowout opening (31) that is provided in the air mix duct and blows out air flowing in the outer passage.

(Aspect 2) The air conditioner according to Aspect 1, wherein the blowout opening is referred to as a first blowout opening, further comprising: a second blowout opening (32) in the air mix duct on an opposite side of the first blowout opening with respect to the guide wall, which blows out air that has passed through the partitioned passage without being blocked by the guide wall.

(Aspect 3) The air conditioner according to Aspect 2, wherein the partitioned passage includes: a first partitioned passage (241) that is provided at a position corresponding to the cooling device and the heating device and guides air blown out of the air conditioning case to a first outlet (25) located in a middle of the air passage; and a second partitioned passage (242) that is provided at a position corresponding to the heating device and guides air blown out of the air conditioning case to a second outlet (26) located on a side of the second blowout opening than the first outlet.

(Aspect 4) The air conditioner according to Aspect 2 or 3, wherein the first blowout opening is connected to a rear duct (41) to blow out air from a rear side of the cabin, and wherein the second blowout opening is connected to a front duct (42) to blow out air from a front side of the cabin.

(Aspect 5) The air conditioner according to any one of Aspects 2-4, wherein a cross-sectional view parallel to a vertical direction of the cabin is referred to as a vertical cross-sectional view, and wherein the air passage formed in the air mix duct has a shape which gradually becomes smaller from a side of the air conditioning case to a side of the second blowout opening in the vertical cross-sectional view.

(Aspect 6) The air conditioner according to any one of Aspects 2-5, wherein a cross-sectional view parallel to a vertical direction of the cabin is referred to as a vertical cross-sectional view, and wherein a cross-sectional view perpendicular to the vertical direction of the cabin is referred to as a lateral cross-sectional view, and wherein the outer passage formed in the air mix duct has a shape which gradually becomes smaller from a side of the guide wall to a side to the first blowout opening in the lateral cross-sectional view and gradually becomes larger from a side of the guide wall to a side of the first blowout opening in the vertical cross-sectional view.

(Aspect 7) The air conditioner according to any one of Aspects 1-6, wherein the cooling device, the heating device, the air conditioning case and the air mix duct are disposed on locations above a center in a vertical direction of the cabin.

(Aspect 8) The air conditioner according to any one of Aspects 1-7, wherein the air conditioner is mounted on a ceiling of the cabin of a manned machinery.

What is claimed is:

1. An air conditioner for an inner space of a cabin, the air conditioner comprising:
a cooling device that cools air;
a heating device that is located downstream of the cooling device and heats the air;
an air conditioning case that accommodates the cooling device and the heating device and blows out cold air that passes through the cooling device and bypasses the heating device, and warm air that passes through the heating device;
an air mix duct that forms an air passage through which cold air and warm air flows from the air conditioning case;
a passage forming member that is provided inside the air mix duct and forms a partitioned passage which partitions a part of the air passage so that cold air and warm air blown from the air conditioning case are guided to a middle of the air passage;
an outer passage that is formed in the air passage of the air mix duct in an area opposite to the partitioned passage with respect to the passage forming member;
a side plate of the air mix duct that forms the outer passage;
a guide wall that is provided downstream from the passage forming member in the air mix duct and is configured to extend in a direction toward an imaginary line that extends a passage center line of the partitioned passage in a downstream side from the side plate forming the outer passage; and
a blowout opening that is provided in the air mix duct and blows out air flowing in the outer passage.

2. The air conditioner according to claim 1, wherein
the blowout opening is referred to as a first blowout opening, further comprising:
a second blowout opening in the air mix duct on an opposite side of the first blowout opening with respect to the guide wall, which blows out air that has passed through the partitioned passage without being blocked by the guide wall.

3. The air conditioner according to claim 2, wherein
the partitioned passage includes:
a first partitioned passage that is provided at a position corresponding to the cooling device and the heating device and guides air blown out of the air conditioning case to a first outlet located in a middle of the air passage; and
a second partitioned passage that is provided at a position corresponding to the heating device and guides air blown out of the air conditioning case to a second outlet located on a side of the second blowout opening than the first outlet.

4. The air conditioner according to claim 2, wherein
the first blowout opening is connected to a rear duct to blow out air from a rear side of the cabin, and wherein
the second blowout opening is connected to a front duct to blow out air from a front side of the cabin.

5. The air conditioner according to claim 2, wherein
a cross-sectional view parallel to a vertical direction of the cabin is referred to as a vertical cross-sectional view, and wherein
the air passage formed in the air mix duct has a shape which gradually becomes smaller from a side of the air conditioning case to a side of the second blowout opening in the vertical cross-sectional view.

6. The air conditioner according to claim 2, wherein
a cross-sectional view parallel to a vertical direction of the cabin is referred to as a vertical cross-sectional view, and wherein
a cross-sectional view perpendicular to the vertical direction of the cabin is referred to as a lateral cross-sectional view, and wherein
the outer passage formed in the air mix duct has a shape which gradually becomes smaller from a side of the guide wall to a side to the first blowout opening in the lateral cross-sectional view and gradually becomes larger from a side of the guide wall to a side of the first blowout opening in the vertical cross-sectional view.

7. The air conditioner according to claim 1, wherein
the cooling device, the heating device, the air conditioning case and the air mix duct are disposed on locations above a center in a vertical direction of the cabin.

8. The air conditioner according to claim 1, wherein
the air conditioner is mounted on a ceiling of the cabin of a manned machinery.
